(19) United States
(12) Patent Application Publication
(10) Pub. No.: US 2024/0246451 A1
(43) Pub. Date: Jul. 25, 2024

(54) SWITCHING REGULATOR INTEGRATED SMART ENERGY CENTER FOR A VEHICLE

(71) Applicant: GM GLOBAL TECHNOLOGY OPERATIONS LLC, DETROIT, MI (US)

(72) Inventors: Chandra S. Namuduri, Troy, MI (US); Suresh Gopalakrishnan, Troy, MI (US); Infane Lowe, Grand Blanc, MI (US); Xinyu Du, Oakland Township, MI (US); Lyall Kenneth Winger, Waterloo (CA)

(21) Appl. No.: 18/157,113

(22) Filed: Jan. 20, 2023

(51) Int. Cl. B60L 58/20; H02M 3/158

(52) U.S. Cl. CPC B60L 58/20; H02M 3/1582; B60L 2210/12; B60L 2210/14

(57) ABSTRACT

A smart energy center for a vehicle is provided. The smart energy center includes a buck convertor configured to provide power to a first load that has a substantially constant resistance level and a boost converter configured to provide power to a second load that requires a minimum voltage level and substantially constant power level. The smart energy center also includes a buck-boost converter configured to provide power to a third load that requires a voltage level within a threshold range and an electronic fuse configured to provide power to a fourth load. The smart energy center further includes a controller configured to operate the buck convertor, the boost converter, the buck-boost converter, and the electronic fuse.

### INTRODUCTION

The disclosure relates to power control systems for a vehicle, and more particularly to a smart energy center having integrated switching regulators.

In general, vehicles include many different electrical systems. These electrical systems include, but are not limited to, infotainment systems, lighting systems, power steering systems, power braking system, driver assistance systems, various sensors, heating and air conditioning systems, and the like. Recently, many vehicles have been equipped with a smart energy center (SEC) that is configured to control the distribution of electrical power to these various electrical systems.

### SUMMARY

In one exemplary embodiment, a vehicle is provided. The vehicle includes a smart energy center configured to receive power from a power source. The smart energy center includes a plurality of switching regulators, wherein a configuration of each of the plurality of switching regulators is determined based upon one or more characteristics of a load that is assigned to the switching regulator and a controller configured to operate each of the plurality of switching regulators.

In addition to the one or more features described herein the configuration includes one of a buck convertor, a boost converter, a buck-boost converter, and an electronic fuse.

In addition to the one or more features described herein the one or more characteristics of the load include a sensitivity of the load to a voltage level.

In addition to the one or more features described herein the one or more characteristics of the load include a variability of a power demand of the load.

In addition to the one or more features described herein the one or more characteristics of the load include a variability of a resistance of the load.

In addition to the one or more features described herein the power source includes one of a generator and an accessory power module.

In addition to the one or more features described herein the power source provides a variable power input.

In addition to the one or more features described herein operating each of the plurality of switching regulators includes controlling a duty cycle of at least one transistor in each of the plurality of switching regulators.

In one exemplary embodiment, a vehicle is provided. The vehicle includes a smart energy center includes a smart energy center configured to receive power from a power source. The smart energy center includes a buck convertor configured to provide power to a first load that has a substantially constant resistance level and a boost converter configured to provide power to a second load that requires a minimum voltage level and substantially constant power level. The smart energy center also includes a buck-boost converter configured to provide power to a third load that requires a voltage level within a threshold range and an electronic fuse configured to provide power to a fourth load. The smart energy center further includes a controller configured to operate the buck convertor, the boost converter, the buck-boost converter, and the electronic fuse.

In addition to the one or more features described herein the power source includes one of a generator or an accessory power module.

In addition to the one or more features described herein the controller operates the buck convertor, the boost converter, the buck-boost converter by controlling a duty cycle of at least one transistor in each of the buck convertor, the boost converter, the buck-boost converter.

In addition to the one or more features described herein the power provided to the first load has a voltage level less than the power received from the power source.

In addition to the one or more features described herein the minimum voltage level is greater than the power received from the power source.

In addition to the one or more features described herein the threshold range is less than one volt.

In one exemplary embodiment, a method for configuring a smart energy center of a vehicle is provided. The method includes identifying one or more characteristics of a load and connecting the load to a buck-boost regulator of the smart energy center based on a determination that the characteristics of the load include a desired voltage range that is less than a threshold value. The method also includes connecting the load to a buck regulator of the smart energy center based on a determination that the voltage characteristics of the load includes a voltage level that is less than an input voltage level and connecting the load to a boost regulator of the smart energy center based on a determination that the voltage characteristics of the load includes a voltage level that is greater than the input voltage level.

In addition to the one or more features described herein the threshold value is one volt.

In addition to the one or more features described herein the input voltage level is twelve volts.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of a vehicle for use in conjunction with one or more embodiments of the present disclosure;

FIG. 2 is a block diagram illustrating a power distribution system for a vehicle in accordance with an exemplary embodiment;

FIG. 3 is a schematic illustrating a switching regulator in a buck regulator configuration in accordance with an exemplary embodiment;

FIG. 4 is a schematic illustrating a switching regulator in a boost regulator configuration in accordance with an exemplary embodiment;

FIG. 5 is a schematic illustrating a switching regulator in a buck-boost regulator configuration in accordance with an exemplary embodiment; and

FIG. 6 is a flowchart illustrating a method for configuring a smart energy center of a vehicle in accordance with an exemplary embodiment in accordance with an exemplary embodiment.

### DETAILED DESCRIPTION

The following description is merely exemplary in nature and is not intended to limit the present disclosure, its application or uses.

As discussed above, many vehicles have recently been equipped with a smart energy center (SEC) that is configured to control the distribution of electrical power to these various electrical systems. Currently available SECs include a plurality of electronic fuses that are used to selectively connect electrical loads to a power source. While the electronic fuses are able to connect/disconnect the loads from a power source, the electronic fuses are not able to provide that current and/or voltage control to individual loads. Disclosed herein is a smart energy center that includes a plurality of switching regulators that are configured to provide current and/or voltage control to individual loads.

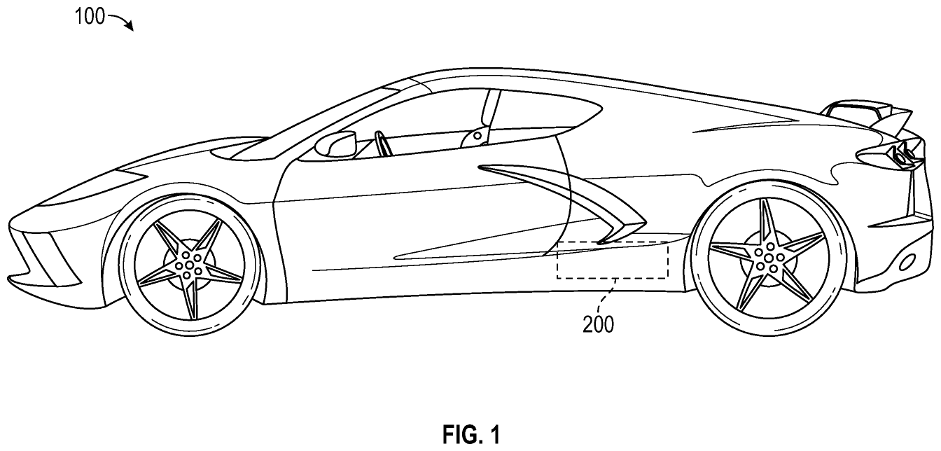

Referring now to FIG. 1, a schematic diagram of a vehicle 100 for use in conjunction with one or more embodiments of the present disclosure is shown. The vehicle 100 includes a power distribution system 200. In one embodiment, the vehicle 100 is a hybrid vehicle that utilizes both an internal combustion engine and an electric motor drive system. In another embodiment, the vehicle 100 is one of an electric vehicle propelled only by an electric motor or multiple electric motors. In another embodiment, the vehicle 100 is of conventional type and propelled by an internal combustion vehicle.

Electric vehicles (EVs) such as battery electric vehicles (BEVs), hybrid vehicles, and/or fuel cell vehicles include one or more electric machines and a high-voltage battery system. A power control system is used to control charging and/or discharging of the high-voltage battery system. The power control system includes an accessory power module (APM) that is configured to provide low-voltage power to one or more electrical systems of the vehicle.

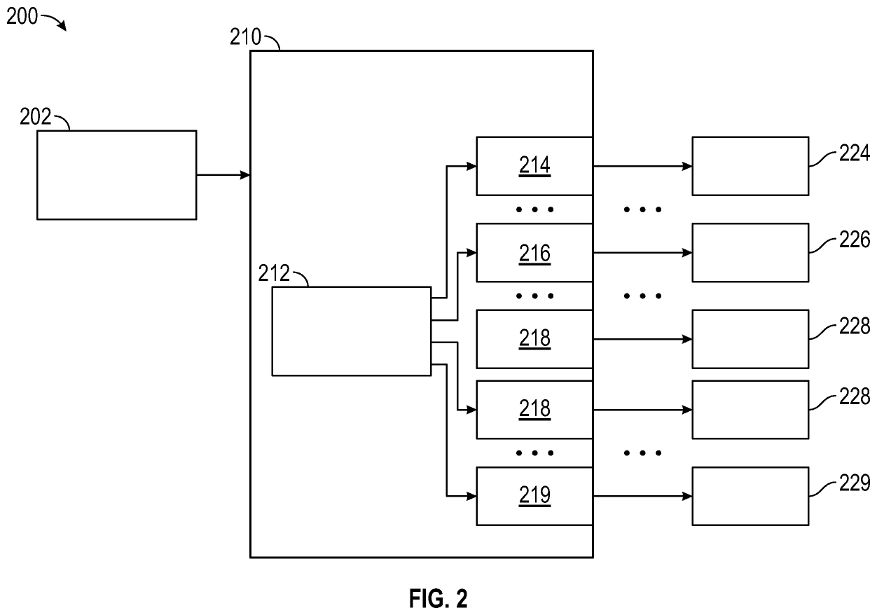

FIG. 2 is a block diagram illustrating a power distribution system 200 for a vehicle in accordance with an exemplary embodiment is shown. The power distribution system 200 includes a power source 202 that is configured to provide power to a smart energy center 210. In one embodiment, the power source 202 is a generator configured to generate electrical power from an internal combustion engine. In another embodiment, the power source 202 is a APM that is configured to receive power from a high-voltage battery system and provide low-voltage power, i.e., approximately twelve-volt power, to the smart energy center 210.

The smart energy center 210 includes a plurality of switching regulators 214, 216, and 218 that are configured to selectively supply power to electrical loads 224, 226, and 228, respectively. In one embodiment, switching regulator 214 is configured as a buck regulator, switching regulator 216 is configured as a boost regulator and switching regulator 218 is configured as a boost-buck regulator. In exemplary embodiments, the smart energy center 210 includes a controller 212 that controls the operation of the switching regulators 214, 216, and 218. The smart energy center 210 also includes one or more electronic fuses 219 that are configured to selectively supply power to electrical loads 229.

In exemplary embodiments, the controller 212 is able to individually control the current and/or voltage that is supplied to each load by its corresponding switching regulator. By adjusting individual load voltages to the optimal levels, the energy consumption of the vehicle can be minimized to improve fuel economy for conventional and hybrid vehicles or range for electric vehicles. In addition, the stability of the voltage provided for various sensitive loads can be significantly improved through the use of switching regulator controls.

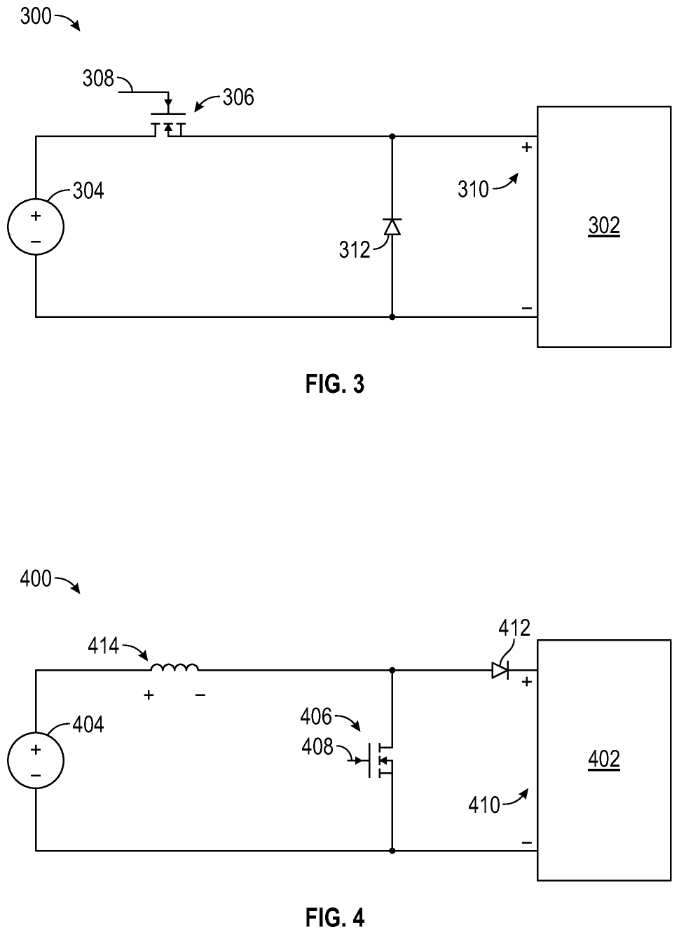

Referring now to FIG. 3 a schematic illustrating a switching regulator 300 in a buck regulator configuration in accordance with an exemplary embodiment is shown. As illustrated, the switching regulator 300 is coupled to a load 302 that is characterized by having a substantially constant resistance. Such loads can include, but are not limited to, a seat heater, a defogger, an interior lighting system or the like. The switching regulator 300 is configured to receive an input voltage (Vᵢₙ) 304, which may be provided by a generator or an APM, and to provide an output voltage (Vₒᵤₜ) 310 to the load 302, where the output voltage 310 is less than the input voltage 304. In exemplary embodiments, the switching regulator 300 includes a diode 312 that is configured to limit the output to a maximum value.

The switching regulator 300 includes a transistor 306 that is controlled by control signal 308. In exemplary embodiments, the duty cycle of the transistor 306, which is determined by the control signal 308, controls the value of the output voltage 310. As a result, the output voltage 310 that is provided to the load 302 can be controlled via the control signal 308.

Referring now to FIG. 4 a schematic illustrating a switching regulator 400 in a boost regulator configuration in accordance with an exemplary embodiment is shown. As illustrated, the switching regulator 400 is coupled to a load 402 that is characterized by a constant power load. The constant power load is a load which requires a substantially constant power, such as a power steering system or an electric brake motor. The switching regulator 400 is configured to receive an input voltage (Vᵢₙ) 404, which may be provided by a generator or and APM, and to provide an output voltage (Vₒᵤₜ) 410 to the load 402, where the output voltage 410 is greater than the input voltage 404.

In exemplary embodiments, the switching regulator 400 includes a diode 412 and an inductor 414. The switching regulator 400 also includes a transistor 406 that is controlled by control signal 408. In exemplary embodiments, the duty cycle of the transistor 406, which is determined by the control signal 408, controls the value of the output voltage 410. As a result, the output voltage 410 that is provided to the load 402 can be controlled via the control signal 408.

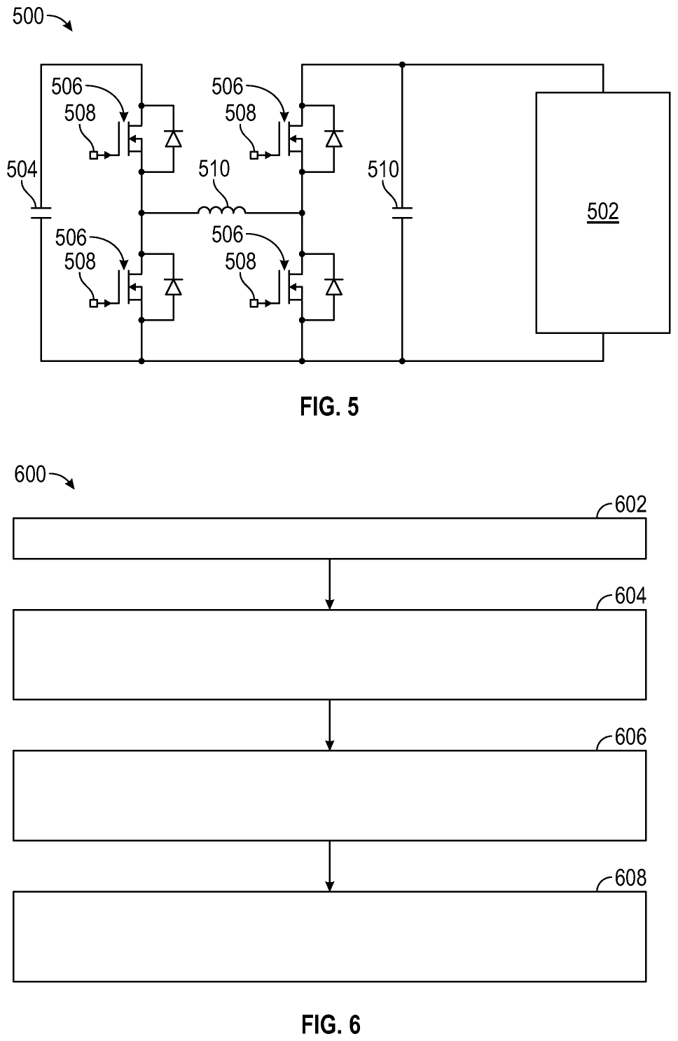

Referring now to FIG. 5 a schematic illustrating a switching regulator 500 in a buck-boost regulator configuration in accordance with an exemplary embodiment is shown. As illustrated, the switching regulator 500 is coupled to a load 502 that is characterized as being sensitive to changes in voltage. Due to this sensitivity, the switching regulator 500 is configured to receive an input voltage (Vᵢₙ) 504 and provide an output voltage (Vₒᵤₜ) 510, where the output voltage is maintained within a specified range between a Vₘᵢₙ and Vₘₐₓ. The switching regulator 500 includes a plurality of transistors 506 that are controlled by control signals 508, which are configured to regulate the output voltage 510. The switching regulator 500 also include an inductor 510.

FIGS. 3, 4, and 5 illustrate exemplary switching regulator in a buck regulator configuration, a boost regulator configuration, and a buck-boost regulator configuration. These exemplary configurations are exemplary in nature and those of ordinary skill in the art will recognize that other suitable buck, boost, and buck-boost regulator configurations can be used.

Returning now to FIG. 2, in exemplary embodiments the controller 212 of the smart energy center 210 is configured to supply one or more control signals to the switching regulators 214, 216, and 218 in order to control the operation of the switching regulators 214, 216, and 218. More specifically, the controller 212 is able to independently control the output voltage of each switching regulators 214, 216, and 218 through the use of various output signals. As a result, the smart energy center 210 is configured to receive a power source 202 that may be variable in nature and to provide individually controlled output voltages to loads 224, 226, and 228, where each output voltage is selected based on a type of the load. In general, the types of loads include constant resistance loads, constant power loads, and voltage sensitive loads which are respectively assigned to a buck regulator, a boost regulator, and a buck-boost regulator. Other loads that do not fall into one of these load types may be assigned to a traditional electronic fuse 219.

In exemplary embodiments, the smart energy center 210 includes one or more sensors that are configured to monitor an output voltage and output current that are provided to each load 224, 226, 228, and 229. The smart energy center 210 is configured to monitor the output voltages and output current provided to each load to identify potential load abnormalities. In one example, the smart energy center 210 is configured to compare the monitored output voltage and current for each load to a stored profile for that load to identify potential load abnormalities.

In exemplary embodiments, the smart energy center 210, via the controller 212, is configured to selectively reduce or boost the output voltage provided to each load 224, 226, 228 based on a deviation of the monitored output voltage from a desired output voltage. For example, based on a determination that an actual output voltage is below a desired output voltage, the controller 212 can adjust the operation of the corresponding switching regulator to increase the output voltage.

Referring now to FIG. 6 a flowchart illustrating a method 600 for configuring a smart energy center of a vehicle in accordance with an exemplary embodiment is shown. At block 602, the method 600 includes identifying one or more characteristics of a load. At block 604, the method 600 also includes connecting the load to a buck-boost regulator of the smart energy center based on a determination that the characteristics of the load include a desired voltage range that is less than a threshold value (i.e., the load is determined to have a high level of sensitivity to variations in voltage). In exemplary embodiments, the threshold value is equal to or less than one volt.

At block 606, the method 600 includes connecting the load to a buck regulator of the smart energy center based on a determination that the characteristics of the load includes a voltage level that is less than an input voltage level. Next, at block 608, the method 600 includes connecting the load to a boost regulator of the smart energy center based on a determination that the characteristics of the load includes a voltage level that is greater than an input voltage level. In exemplary embodiments, the input voltage is in the range of 12-15.5V.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
a smart energy center configured to receive power from a power source, the smart energy center comprising:
a plurality of switching regulators, wherein a configuration of each of the plurality of switching regulators is determined based upon one or more characteristics of a load that is assigned to the switching regulator; and
a controller configured to operate each of the plurality of switching regulators.

2. The vehicle of claim 1, wherein the configuration includes one of a buck convertor, a boost converter, a buck-boost converter, and an electronic fuse.

3. The vehicle of claim 1, wherein the one or more characteristics of the load include a sensitivity of the load to a voltage level.

4. The vehicle of claim 1, wherein the one or more characteristics of the load include a variability of a power demand of the load.

5. The vehicle of claim 1, wherein the one or more characteristics of the load include a variability of a resistance of the load.

6. The vehicle of claim 1, wherein the power source includes one of a generator and an accessory power module.

7. The vehicle of claim 1, wherein the power source provides a variable power input.

8. The vehicle of claim 1, wherein operating each of the plurality of switching regulators includes controlling a duty cycle of at least one transistor in each of the plurality of switching regulators.

9. A vehicle comprising:
a smart energy center configured to receive power from a power source, the smart energy center comprising:
a buck convertor configured to provide power to a first load that has a substantially constant resistance level;
a boost converter configured to provide power to a second load that requires a minimum voltage level and substantially constant power level;
a buck-boost converter configured to provide power to a third load that requires a voltage level within a threshold range;
an electronic fuse configured to provide power to a fourth load; and
a controller configured to operate the buck convertor, the boost converter, the buck-boost converter, and the electronic fuse.

10. The vehicle of claim 9, wherein the power source includes one of a generator or an accessory power module.

11. The vehicle of claim 9, wherein the power source provides a variable power input.

12. The vehicle of claim 9, wherein the controller operates the buck convertor, the boost converter, the buck-boost converter by controlling a duty cycle of at least one transistor in each of the buck convertor, the boost converter, the buck-boost converter.

13. The vehicle of claim 9, wherein the power provided to the first load has a voltage level less than the power received from the power source.

14. The vehicle of claim 9, wherein the minimum voltage level is greater than the power received from the power source.

15. The vehicle of claim 9, wherein the threshold range is less than one volt.

16. The vehicle of claim 10, wherein the accessory power module is configured to receive a high-voltage power and create a low-voltage power.

17. A method for configuring a smart energy center of a vehicle, the method comprising:
identifying one or more characteristics of a load;
connecting the load to a buck-boost regulator of the smart energy center based on a determination that the characteristics of the load include a desired voltage range that is less than a threshold value;
connecting the load to a buck regulator of the smart energy center based on a determination that the voltage characteristics of the load includes a voltage level that is less than an input voltage level; and
connecting the load to a boost regulator of the smart energy center based on a determination that the voltage characteristics of the load includes a voltage level that is greater than the input voltage level.

18. The method of claim 17, wherein the characteristics of the load include a variability of a resistance of the load.

19. The method of claim 17, wherein the threshold value is one volt.

20. The method of claim 17, wherein the input voltage level is twelve volts.
